(19) United States
(12) Patent Application Publication
(10) Pub. No.: US 2003/0196107 A1
(43) Pub. Date: Oct. 16, 2003

(54) Protocol, system, and method for transferring user authentication information across multiple, independent internet protocol (IP) based networks

(76) Inventors: Samuel A. Robertson, Lafayette, LA (US); Ann O'Quain, Lafayette, LA (US); Bryan K. Copeland, Lafayette, LA (US)

Correspondence Address: ROBERT N. MONTGOMERY, 109 BROWNLEE AVE., BROUSSARD, LA, 70518-3021, US

(21) Appl. No.: 10/123,577

(22) Filed: Apr. 15, 2002

(51) Int. Cl. H04L 9/32

(52) U.S. Cl. 713/200

(57) ABSTRACT

A protocol for transferring user authentication information across independent IP networks, for allowing a roaming user to access IP network resources from any IP network location having connectivity to an internet protocol based shared authentication network (IPSAN) thereby utilizing the resources of any affiliated network regardless of user's location.

### FIELD OF THE INVENTION

This invention relates generally to an Internet Protocol (IP) as established by the Internet Engineering Task Force (IETF) under (RFC 791) and referred to herein as a Shared Authentication Protocol (IPSAP) and more particularly to a method used to transfer network and user authentication information for a roaming computer user across multiple IP networks having varying configurations, physical mediums, authentication programs, and existing on separate routable subnets by utilizing a centralized database for locating the user's home or local network provider and verifying authentication with the user's home network while utilizing the resources of another affiliated IP network.

### GENERAL BACKGROUND

Traditionally, IP networks are designed to allow authentication and access by users to a single IP network. The network administrator enters the users authentication information (username/password) into the central authentication server. The authentication information will be used to validate the user when said user attempts to connect to the local IP network. Any user wanting to gain access to resources of the IP network must obtain a username/password from the network administrator of that IP network. If a user requires access to multiple IP networks, a separate username/password is obtained from each network administrator for each IP network user will connect to.

Corporate networks and Internet service providers are constantly expanding as a result of mergers, acquisitions, and partnerships. These networks often utilize different authentication programs for user authentication. Traditionally when combining two different IP networks all user information must be re-keyed into the new system, a long, tedious and expensive project. Further, when combining the user's information from both IP networks, many of the same usernames exist on both IP networks. When such conflicts arise, one of the users must change his or her username resulting in a change of the user's e-mail address.

The above problems indicate that there is a need to provide a way to join multiple (IP) networks with unique authentication programs (Microsoft, UNIX, or Radius technologies) already in place, thereby allowing the user of one IP network to be linked and utilize the resources of another IP network while using existing authentication information already available at the user's home IP network. There is also a need for the ability to add and remove IP networks without reconfiguration of all IP networks served by the host server. Further, users would need a way to identify which IP network they are using at any given time and if any special terms of use are required. It is Therefore an object of the instant invention is to address each of the above problems and provide a workable system for allowing a user to authenticate across multiple IP networks and roam at will.

### SUMMARY OF THE INVENTION

The instant invention provides methodology, process, and apparatus for transferring shared user authentication information across multiple independent IP networks whereby an apparatus (IPSAP base server) resides at each IP network. The IPSAP base server exchanges information with the IP network's existing authentication program. Each IPSAP base server is given a unique identifier name (net-id) and Pretty Good Privacy (PGP) public/private keys technology (IETF RFC 1991 PGP Message Exchange Formats) to identify the IP network to which it is connected and to provide the basis for encryption of data transferred. The IPSAP base server locates the IPSAP base servers of other IP networks by querying an IPSAP central server having the net-id of the destination IP network and then returning the IP addresses of the destination IPSAP base server and the PGP public key for the requested IPSAP base server. The originating IPSAP base server then exchanges authentication information with the destination IP network's IPSAP base server independent of the IPSAP central server, thereby allowing independent trust relationships to be maintained by each of the separate IP network providers. Remote Authentication Dial In User Service (RADIUS) authentication (IETF RFC 2138) is used to interface the IPSAP base server with the existing authentication program.

Software is provided that utilizes the user's authentication information to carry the user's IPSAP base net-id prefixed in the format of “net-id/username”. This net-id prefix allows the local IPSAP base server to identify where the user's authentication records are stored. Using this method allows the IP network to use its existing authentication program without modification.

By using an added Dynamic Host Configuration Protocol (DHCP) (IETF RFC 1541) option “net-id” also allows the user to identify the IP network being used at any given time. Software on the user's computer also determines additional public information about the IP network and then acquires configuration information from the IPSAP central server and the local IPSAP base server.

### BRIEF DESCRIPTION OF THE DRAWINGS

For a further understanding of the nature and objects of the present invention, reference should be made to the following detailed description taken in conjunction with the accompanying drawings, in which, like parts are given like reference numerals, and wherein:

FIG. 1 is a pictorial illustration of the communication routing for authentication;

FIG. 2 is a process flow diagram for user authentication;

FIG. 2a is a continuation of the process flow diagram shown in FIG. 2; and

FIG. 3 is a process flow diagram for the server authentication.

### DETAILED DESCRIPTION OF THE PREFERRED EMBODIMENT

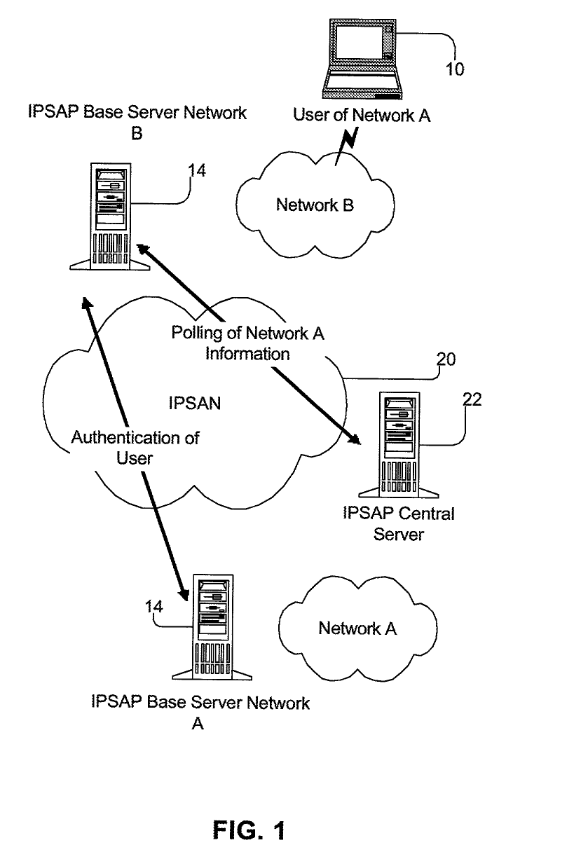

Looking first at FIG. 1 we see that the Internet Protocol Shared Authentication Network (IPSAN) consists of an IPSAP base server 14, which is a device that consists of physical storage, a processor, memory, and connectivity to an IP network, with required IPSAP software installed, and the IPSAP central server 22, which is a device that consists of physical storage, a processor, memory, and connectivity to an IP network, with required IPSAP software installed. A user system 10, is a device that consists of physical storage, a processor, memory, and connectivity to an independent IP network, with a software protocol program to authenticate the user and his network location within the IPSAN. The proposed system indicates that a computer user 10, who has connectivity or subscribes to a first host network-“A”, as his/her home IP network provider may utilize the services of a second network-“B” without subscribing thereto provided that network-“B” has connectivity to the IPSAN described herein that has acquired an IPSAP base server 14. The type of connectivity is irrelevant since the system is capable of utilizing all forms of communication that are IP based. The roaming user 10 may make connection to the IPSAN 20 via network-“B” regardless of user's location, provided the user's home IP network-“A” also has an IPSAP base server 14. In this manner two-way communication is established between a plurality of IPSAP base servers 14 and the IPSAP central server 22 without the need to change user authentication information, usually required by different independent IP networks. In this case the IPSAP base servers 14 may query each other and communicate with the IPSAP central server 22 for authentication regardless of user's location. Exchanged data base information between the IPSAP base servers 14 and the IPSAP central server 22 may contain user connection information, phone numbers, ESSID's (Extended Service Set Identifier), and other such pertinent information, all encrypted through the PGP public/private keys.

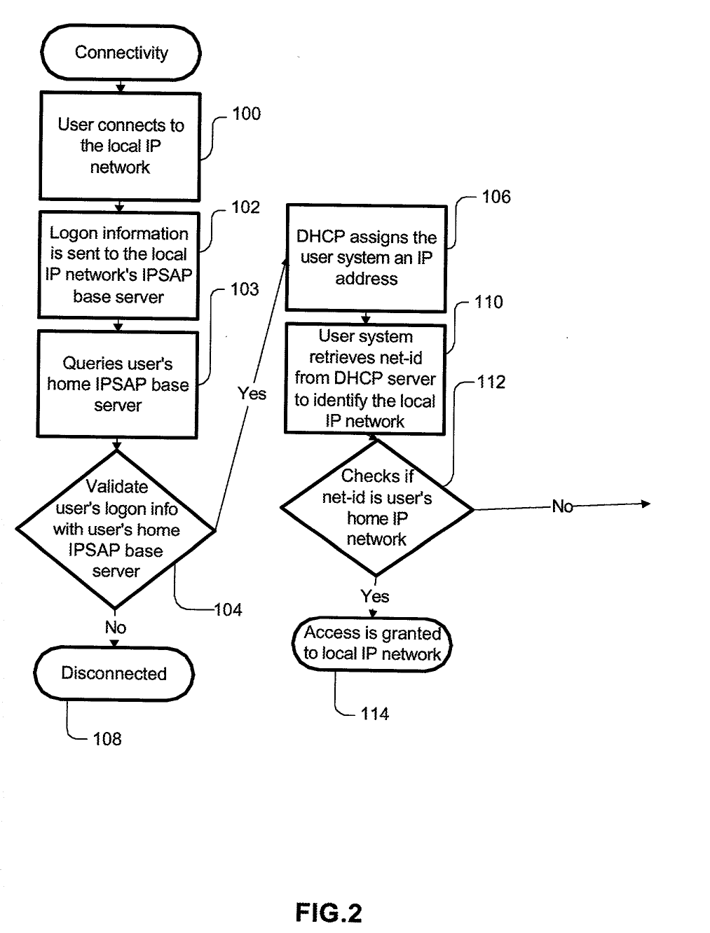

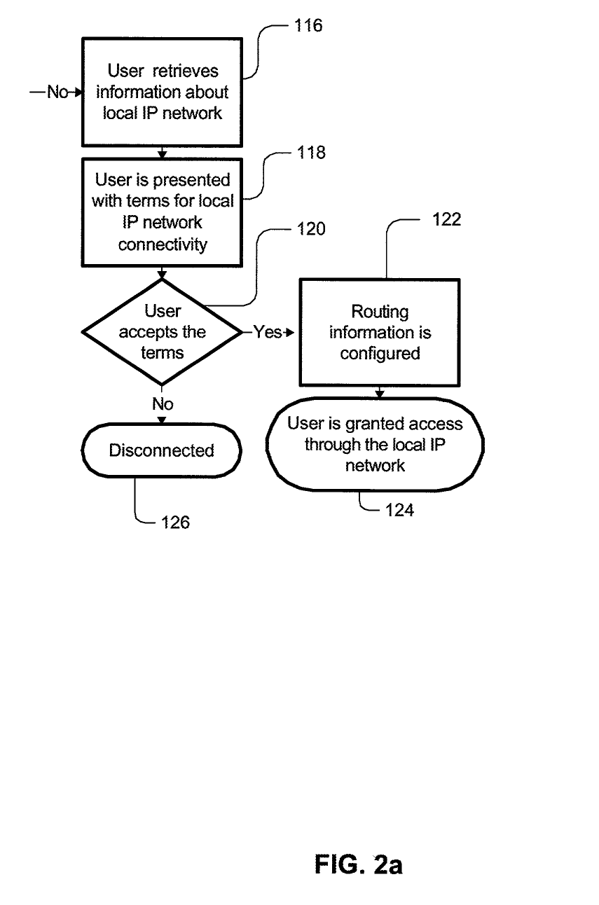

As illustrated in FIG. 2, communication links for connectivity within the affiliated IP based Authentication Shared Protocol (IPSAP) network is accomplished whereby a user 10 (illustrated in FIG. 1) establishes a one step user logon connection 100 in some manner, such as by phone line, optic cable or wireless communication, with a local IP network listed as having connectivity with an IPSAP network central server 22 (as seen in FIG. 1) and therefore a member of an affiliated group of affiliated independent networks equipped with an IPSAP base server 14( seen in FIG. 1). In the next step 102 the user's logon information is sent to a local IP network's IPSAP base server 14, which queries 103 the user's home IPSAP base server 14 i.e. network-“A”. The user's authentication information, which has been supplemented with the user's IPSAP base network identifier (net-id) in the format of “net-id/username” allows the local IPSAP base server to identify where the user's authentication records are stored, thus allowing the IP networks to utilize the existing authentication program of each IP network without modification. The next step 104 authenticates the user's logon information by validating said data with the user's home IPSAP base server. If the Logon data is validated, the next step 106 allows the local IP network 22, utilizing DHCP, to assign the user an IP address and connection is established. If the logon data fails to validate with the encoded data at the user's home IPSAP base server the connection is terminated 108. The next step 110 allows the user's system to retrieve “net-id” from the DHCP server at the local IP network in order for the user to identify the local IP network being accessed by the user. The next step 112 determines if the “net-id” is the user's home IP network. If so, access to the local IP network is granted 114. If not, the next step 116 (seen in FIG. 2a) allows the user to retrieve information about the local IP network. The following step 118 (seen in FIG. 2a) provides the user with the terms for local IP network connectivity. User either accepts the terms, thereby allowing routing information to be configured 122 and access granted 124. or rejects the terms, whereby the user is disconnected 126.

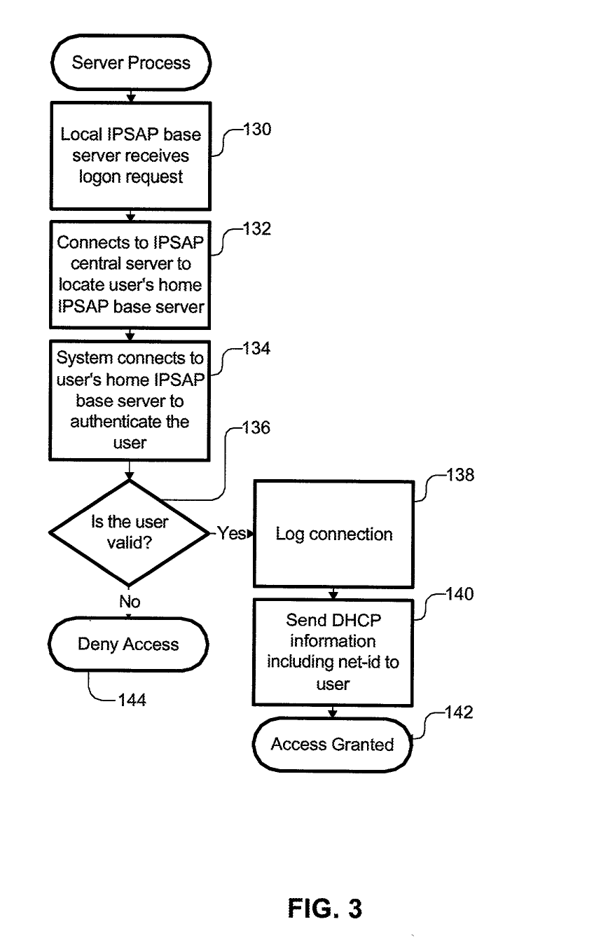

Looking now at FIG. 3 we see that when a local IPSAP base server 14 (illustrated in FIG. 1) receives a logon request 130 the local IPSAP base server 14 connects 132 and queries the IPSAP central server 22 to locate the user's home IPSAP base server. This is done through an exchange of PGP public/private keys for encryption of data. The local IPSAP base server then connects 134 to the user's home IPSAP base server to authenticate the user. The data is encrypted through another set of PGP public/private keys unique to each IPSAP base server. The user's authentication information is validated 136. If valid, the system logs the connection 138 and sends DHCP information 140 including “net-id” and grants access 142. If the user's information at logon is invalid 136, access is denied 144.

Because many varying and different embodiments may be made within the scope of the inventive concept herein taught, and because many modifications may be made in the embodiments herein detailed in accordance with the descriptive requirement of the law, it is to be understood that the details herein are to be interpreted as illustrative and not in any limiting sense.

What is claimed is:

1. An Internet Protocol based Shared Authentication Protocol (ISAP) utilizing a single step user logon to an affiliation of independent IP networks having a plurality of authentication programs whereby a user of any one of the IP networks is allowed to gain access to any IP network by way of any of the affiliated independent IP network's resources, the IPSAP comprising:
a) establishing a communication link between each affiliated independent IP based network through a base server connected to and located at each affiliated network with each base server, having a unique network identifier name;
b) establishing a communication link between each said base server and a remote central server said central server providing authentication and encryption for said affiliated independent networks; and
c) utilizing a user's existing logon name in combination with user's said network identifier name in the format of net-id/username for authentication and authorization as a registered user of one of said affiliated independent IP based networks for accessing the resources of any of said affiliated independent IP based networks.

2. The protocol according to claim 1 further comprising a means for user identification of the IP network to which said user is connected and the terms applicable to its use by said user.

3. An Internet Protocol Shared Authentication protocol system comprising:
a) a plurality of independent IP based networks having a plurality of authentication programs;
b) a base server having a unique digital identifier name located at and in communication with each of said independent IP based networks;
c) a central server in communication with each said base server;
d) a software program loaded on each said base server having means for identifying and authenticating a user of any of said IP based networks using only said user's home IP network identification and username in the format of net-id/username;
e) a means for allowing each said base server to communicate with any of said plurality of IP based network's base server independently of said central server; and
f) a software program loaded on said central server having means for identifying said base servers and providing PGP public keys for authentication between each said base server.

4. An IPSAP comprising a means for allowing a roaming user to utilize the resources of an affiliated group of independent IP based networks having different authentication programs, said means comprising an IPSAP base server having a unique identifier name located at each of said independent IP base networks, said base server being in communication with each said IP based network, an IPSAP central server in communication with each said IPSAP base servers providing communication between said affiliated independent IP based networks, a means for identifying and authenticating any of said independent IP networks and their users and thereby allowing access to any of said affiliate independent IP network's resources by a user of any of said affiliated independent networks regardless of user's access provider network, and a means for maintaining independent trust relationships between each of said independent IP networks.

5. The IPSAP, according to claim 4, wherein each of said IPSAP base servers are capable of exchanging authentication information with other network IPSAP base servers, independently of said IPSAP central server.

6. The IPSAP according to claim 5 further comprises PGP public/private keys as a means of encrypting user authentication information exchanged between IPSAP base servers.

7. The IPSAP according to claim 5 further comprises “RADIUS” authentication to interface with existing authentication programs.

8. The IPSAP, according to claim 4, wherein said means for identifying an IP network user is by prefixing the user's authentication information in the format of “net-id/username”.

9. The IPSAP, according to claim 4, further comprises a means for allowing users of one of said affiliated group of independent IP networks to utilize the resources of any other said IP network by utilizing the existing authentication information of each IP Network connected to the IPSAP system.

10. The IPSAP, according to claim 4, further includes means for user identification of the IP network to which they are currently connected and the terms for connectivity by a user applicable to that IP network.

11. A method for IP based network connectivity by a computer user subscribing first to an independent IP network host by way of a second independent IP network host, thereby utilizing the resources of the second independent IP network host provider without subscribing thereto comprising the steps of:
a) providing an IPSAP base server having a unique identifier name and PGP public/private keys located at each of a plurality of independent IP network host each IPSAP base server in communication with said host's IP network;
b) providing an IPSAP central server in communication with each of said IPSAP base servers;
c) providing authentication information for each IP network user with said unique identifier name as a prefix;
d) authenticating a user and allowing connection upon logon utilizing said IPSAP base server to query said IPSAP central server for authentication of the originating IPSAP base server and obtaining a destination IP address and PGP public key; and
e) exchanging authentication information between said destination IPSAP base server and said origination IPSAP base server independent of said IPSAP central server.

12. The method of connection according to claim 11 further including the step of using a DHCP option “net-id” to identify which IP network is being utilized by a user to communicate with the host IP network subscribed to by said user.
